(19) United States
(12) Patent Application Publication
(10) Pub. No.: US 2012/0215541 A1
(43) Pub. Date: Aug. 23, 2012

(54) SIGNAL PROCESSING METHOD, DEVICE, AND SYSTEM

(75) Inventors: Yuanyuan Liu, Beijing (CN); Zhe Wang, Beijing (CN); Eyal Shlomot, Long Beach, CA (US)

(73) Assignee: Huawei Technologies Co., Ltd., Shenzhen (CN)

(21) Appl. No.: 13/458,524

(22) Filed: Apr. 27, 2012

Related U.S. Application Data
(63) Continuation of application No. 13/445,439, filed on Apr. 12, 2012.
Application No. 13/445,439 is a continuation of application No. PCT/CN2010/077760, filed on Oct. 15, 2010.

(30) Foreign Application Priority Data
Oct. 15, 2009 (CN) 200910110792.7

(51) Int. Cl. G10L 19/00; G10L 11/00

(52) U.S. Cl. 704/270; 704/500; 704/E21.001; 704/E19.001

(57) ABSTRACT

A signal identifying method includes obtaining signal characteristics of a current frame of input signals; deciding, according to the signal characteristics of the current frame and updated signal characteristics of a background signal frame before the current frame, whether the current frame is a background signal frame; detecting whether the current frame serving as a background signal frame is in a first type signal state; and adjusting a signal classification decision threshold according to whether the current frame serving as a background signal frame is in the first type signal state to enhance the speech signal identification capability.

### CROSS-REFERENCE TO RELATED APPLICATIONS

This application is a continuation of U.S. patent application Ser. No. 13/445,439, filed on Apr. 12, 2012, which is a continuation of International Application No. PCT/CN2010/077760, filed on Oct. 15, 2010. The International Application claims priority to Chinese Patent Application No. 200910110792.7, filed on Oct. 15, 2009. The afore-mentioned patent applications are hereby incorporated by reference in their entireties.

### FIELD OF THE APPLICATION

Embodiments of the present application relate to the communication or network field, in particular, to a signal processing technology, and specifically, to a signal identifying and analyzing method, device, and system.

### BACKGROUND OF THE APPLICATION

Speech coding technologies can compress the transmission bandwidth of speech signals and increase the capacity of a communication system. With the popularity of the Internet and further expansion of the communication field, the speech coding technologies become one of the most active fields in China and around the world. With the progress of time, speech coders are developing toward multi-rate and wideband, and the input signals of speech coders also tend to be diversified, including not only speech signals, but also other signals such as music. In addition, people require higher quality of conversation, and especially, the quality of music signals. For different input signals, coders of different bit rates or even of different core coding algorithms may be used to ensure the coding quality of different types of signals and save bandwidth maximally, which has become a development trend of speech coders. Therefore, accurately identifying the type of input signals also becomes a hot topic of research in the industry.

In an application scenario of signal classification, as shown in FIG. 1, original signals are converted by a voice collection device into input signals that can be coded; the input signals are classified before being coded, that is, different types of signals in the input signals are identified; different types of signals are coded by coders of different coding algorithms to obtain coded signals; the coded signals are converted into coded bit streams and then sent to the decoder; different types of signals are decoded by using different decoders, and the decoded signals are further restored to the original signals and input to the receiver.

A decision tree is a method widely used for classifying signals. A long-term decision tree and a short-term decision tree are used together to decide the type of signals. First, a FIFO (First-In First-Out, first in first out) memory of a specific time length is set to buffer short-term signal characteristic variables; long-term signal characteristics are calculated according to the short-term signal characteristic variables of the same time length as the previous one, where the same time length as the previous one includes the current frame; and the speech signals and music signals are classified according to the calculated long-term signal characteristics. In the same time length before the signals begin, that is, before the FIFO memory is full, a decision is made according to the short-term signal characteristics. In both the short-term decision and the long-term decision, the decision trees shown in FIG. 2 and FIG. 3 are applied.

The solution of the prior art is inapplicable to various circumstances of speech signals, for example, when the background noise of speech signals is music, because the characteristics of music signals weaken the characteristics of speech signals, some speech frames are identified as other types of signal frames if the solution of the prior art is used. Therefore, the ratio of incorrectly decided signals is high, which decreases the signal identification capability and greatly affects the quality of signal processing, for example, decreases the efficiency of signal coding, accuracy of signal transmission, and authenticity of the restored original signals.

### SUMMARY OF THE APPLICATION

Embodiments provide a compression coding method and device, a compression decoding method, and a compression coding device to enhance the signal identification capability and ensure the signal quality.

An embodiment provides a signal identifying method, including:

obtaining signal characteristics of a current frame of input signals; deciding, according to the signal characteristics of the current frame and updated signal characteristics of a background signal frame before the current frame, whether the current frame is a background signal frame; detecting whether the current frame is in a first type signal state; and adjusting a signal classification decision threshold according to whether the current frame is in the first type signal state.

Another embodiment also provides a signal identifying method, including:

deciding, according to signal characteristics of a current frame and updated signal characteristics of a background signal frame before the current frame, whether the current frame is a background signal frame; obtaining tonal characteristics of the current frame serving as a background signal frame and tonal characteristics of multiple background signal frames before the current frame; correlating the tonal characteristics of the current frame and the tonal characteristics of the multiple background signal frames before the current frame; and comparing the correlated tonal characteristics with a first threshold, and determining, according to a comparison result, whether the current frame serving as the background signal frame is a first type signal.

Another embodiment provides a signal classifying method, including:

making a first decision according to signal characteristics of a current frame and updated signal characteristics of a background signal frame before the current frame to decide whether the current frame is a useful signal frame; obtaining the signal characteristics of the current frame serving as a useful signal frame and signal characteristics of multiple useful signal frames before the current frame; and making a second decision according to the signal characteristics of the current frame and the signal characteristics of the multiple useful signal frames before the current frame to decide the signal type of the current frame, where the first decision or second decision is made based on a signal classification decision threshold, and the signal classification decision threshold is obtained through adjustment according to whether the current frame or the background signal frame before the current frame is in a first type signal state.

Another embodiment provides a signal identifying device, including:

a background signal deciding module, configured to decide, according to signal characteristics of a current frame and updated signal characteristics of a background signal frame before the current frame, whether the current frame is a background signal frame; a signal characteristic detecting module, configured to detect whether the current frame is in a first type signal state; and a first threshold adjusting module, configured to adjust a signal classification decision threshold according to whether the current frame is in the first type signal state.

Another embodiment provides a signal identifying device, including:

a background signal deciding module, configured to decide, according to signal characteristics of a current frame and updated signal characteristics of a background signal frame before the current frame, whether the current frame is a background signal frame; a tonal characteristic obtaining module, configured to obtain tonal characteristics of the current frame serving as a background signal frame and tonal characteristics of multiple background signal frames before the current frame; a signal characteristic correlating module, configured to correlate the tonal characteristics of the current frame and the tonal characteristics of the multiple background signal frames before the current frame; and a first type signal module, configured to compare the correlated tonal characteristics with a first threshold, and determine, according to a comparison result, whether the current frame serving as the background signal frame is a first type signal.

Another embodiment provides a signal classifying device, including:

a signal judging module, configured to make a first decision according to signal characteristics of a current frame and updated signal characteristics of multiple background signal frames before the current frame to decide whether the current frame is a useful signal frame; a signal characteristic module, configured to obtain the signal characteristics of the current frame serving as a useful signal frame and the signal characteristics of the multiple useful signal frames before the current frame; and a signal deciding module, configured to make a second decision according to the signal characteristics of the current frame and the signal characteristics of the multiple useful signal frames before the current frame to decide the signal type of the current frame, where the first decision or second decision is made based on a signal classification decision threshold, and the signal classification decision threshold is obtained through adjustment according to whether the current frame or a background signal frame before the current frame is in a first type signal state.

Another embodiment provides a signal processing system, including:

a signal characteristic obtaining device, configured to obtain signal characteristics of a current frame of input signals; a signal identifying device, configured to detect, according to the signal characteristics of the current frame, whether the current frame is a background signal frame, and adjust a signal classification decision threshold according to whether the current frame as a background signal frame is in a first type signal state; a signal classifying device, configured to decide, according to the signal characteristics of the current frame, whether the current frame is a useful signal frame, and decide the signal type of the current frame serving as a useful signal frame, where the decision on whether the current frame is a useful signal frame or the decision on the signal type of the current frame serving as a useful signal frame is made based on the signal classification decision threshold, and the signal classification decision threshold is obtained through adjustment according to whether the current frame or a background signal frame before the current frame is in the first type signal state.

Another embodiment provides an audio signal coding system, including:

a signal inputting device, configured to receive audio signals; a signal classifying device, configured to decide, according to signal characteristics of a current frame, whether the current frame is a useful signal frame, and decide the signal type of the current frame serving as a useful signal frame, where the decision on whether the current frame is a useful signal frame or the decision on the signal type of the current frame serving as a useful signal frame is made based on a signal classification decision threshold, and the signal classification decision threshold is obtained through adjustment according to whether the current frame or a background signal frame before the current frame is in a first type signal state; and a signal coding device, configured to use, according to the signal type of the current frame that is decided as a useful signal frame, coders to perform coding for different types of signals to obtain coded bit streams of different types of signals.

Another embodiment provides a signal deciding method, including:

obtaining signal characteristics of a current frame of input signals, deciding whether the current frame is in a first type signal state, and determining a signal classification decision threshold according to whether the current frame is in the first type signal state; and

comparing the determined signal classification decision threshold with the signal characteristics of the current frame to decide the signal type of the current frame.

Another embodiment provides a signal deciding device, including:

a module configured to obtain signal characteristics of a current frame of input signals;

a module configured to decide whether the current frame is in a first type signal state, and determine a signal classification decision threshold according to whether the current frame is in the first type signal state; and

a module configured to compare the determined signal classification decision threshold with the signal characteristics of the current frame to decide the signal type of the current frame.

Therefore, according to the embodiments, the non-speech background in the signals can be identified, and the signal classification decision threshold is adjusted after the non-speech background in the signals is identified. The adjustment of the threshold effectively reduces the ratio of erroneous recognition of signals, and enhances the capability of identifying the speech signals in the non-speech background and the signal processing quality.

### BRIEF DESCRIPTION OF THE DRAWINGS

To make the technical solutions of the embodiments clearer, the accompanying drawings for describing the embodiments are briefly described hereunder. Evidently, the accompanying drawings illustrate only some embodiments and persons of ordinary skill in the art can obtain other drawings based on the drawings without creative efforts.

FIG. 1 is a schematic diagram of an application scenario of signal classification in the prior art;

FIG. 2 is a schematic diagram of a short-term decision of a decision tree for signal classification in the prior art;

FIG. 3 is a schematic diagram of a long-term decision of a decision tree for signal classification in the prior art;

FIG. 4 is a schematic diagram of an embodiment of a signal identifying method according to the present invention;

FIG. 5 is a schematic diagram of an embodiment of another signal identifying method according to the present invention;

FIG. 6(a) and FIG. 6(b) are schematic diagrams of an embodiment of another signal identifying method according to the present invention;

FIG. 7 is a schematic diagram of an embodiment of another signal identifying method according to the present invention;

FIG. 8 is a schematic diagram of an embodiment of a signal classifying method according to the present invention;

FIG. 9 is a schematic diagram of an embodiment of another signal identifying method according to the present invention;

FIG. 10 is a schematic diagram of an embodiment of another signal identifying method according to the present invention;

FIG. 11 is a schematic diagram of an embodiment of a signal processing system according to the present invention;

FIG. 12(a) and FIG. 12(b) are schematic diagrams of an embodiment of another signal processing system according to the present invention;

FIG. 13(a) and FIG. 13(b) are schematic diagrams of an embodiment of a signal identifying device according to the present invention;

FIG. 14 is a schematic diagram of an embodiment of another signal identifying device according to the present invention;

FIG. 15 is a schematic diagram of an embodiment of a signal classifying device according to the present invention;

FIG. 16 is a schematic diagram of an embodiment of an audio signal coding system according to the present invention; and

FIG. 17 is a schematic diagram of an embodiment of a signal deciding method according to the present invention.

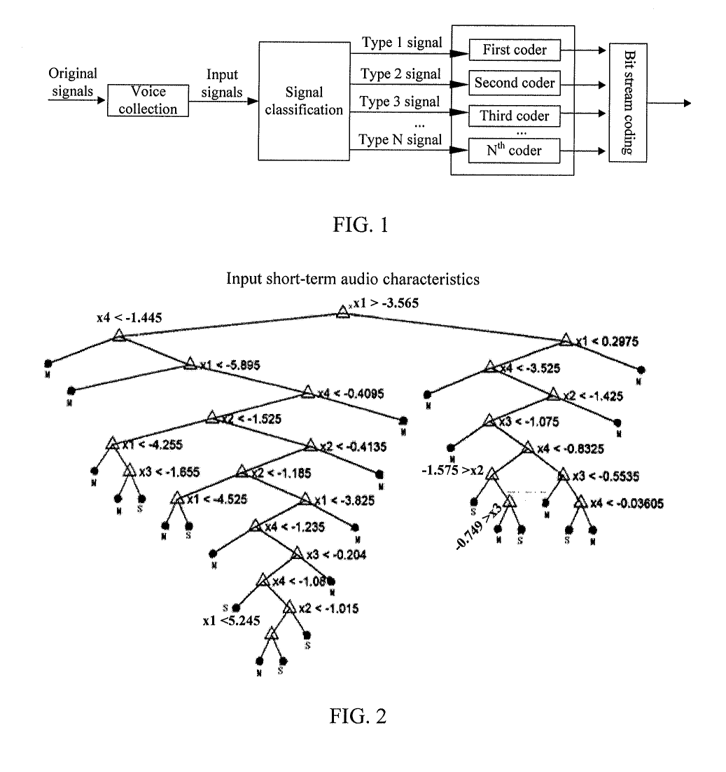

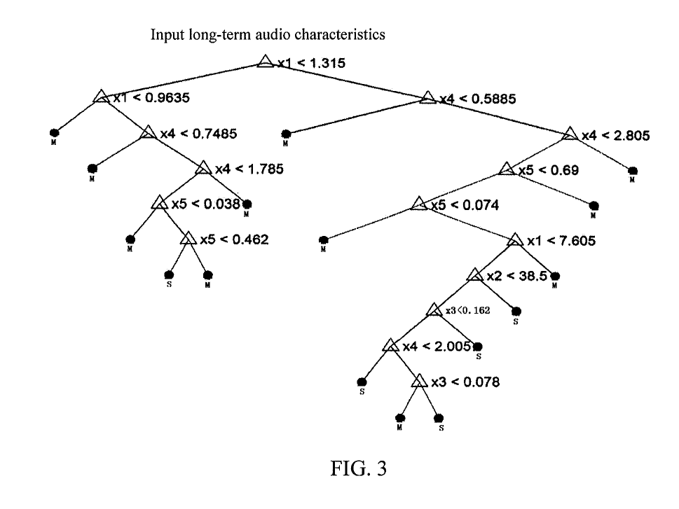

### DETAILED DESCRIPTION OF THE EMBODIMENTS

The technical solutions of the embodiments are hereinafter described clearly and completely with reference to the accompanying drawings. It is evident that the described embodiments are only some, rather than all embodiments. Based on the embodiments, all other embodiments that can be derived by persons of ordinary skill in the art without creative efforts shall fall within the protection scope of the claims.

### Embodiment 1

### Signal Identifying Method

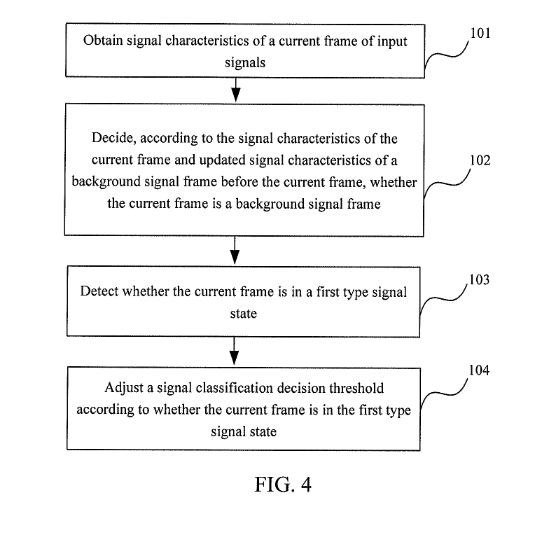

FIG. 4 is a schematic diagram of an embodiment of a signal identifying method, including the following steps:

Step 101: Obtain signal characteristics of a current frame of input signals.

The input signals are divided into frames, and each operation step of this embodiment is performed with a frame as an operation unit one by one. Here the input signals may be audio signals. The audio signals may be classified into foreground signals and background signals according to signal environments. The foreground signals and background signals may be further classified into speech and non-speech signals such as music signals according to the characteristics of the audio signals. Certainly, in different application scenarios, signals may be classified into other types according to specific environments and audio signals. Embodiments are described by taking only the foreground signals and background signals and the speech and non-speech signals as examples. For each frame of audio signals, a signal frame being currently processed is called a current frame. The characteristic parameters of the current frame are extracted to obtain the signal characteristics of the current frame. The signal characteristics of the frame may include all or a part of characteristics reflecting the physical characteristics of a signal, such as, signal-to-noise ratio characteristic and energy characteristic. The signal characteristics may participate in signal identification in the form of characteristic parameters. According to different environment characteristics and application requirements, characteristic parameters may be selected and extracted in different ways to obtain the signal characteristics of the current frame. For ease of understanding and description, the embodiment is described by only using the signal-to-noise ratio of the signal frame as the signal characteristic of the current frame.

Step 102: Decide, according to the signal characteristics of the current frame and updated signal characteristics of a background signal frame before the current frame, whether the current frame is a background signal frame.

Different signal characteristics may be used to differentiate different types of audio signals classified according to different standards. Whether the current frame is a background signal frame may be decided according to the signal characteristics of the current frame and the updated signal characteristics of the background signal frame before the current frame. Generally, the background signal frame may be understood as background noise or background music in a usual sense. This step is to differentiate a background signal from the audio signals, and decide whether the current frame is a background signal frame. For a first frame before the current frame or one of multiple background signal frames before the current frame, after the signal characteristics of the background signal frame are updated, the updated signal characteristics and the signal characteristics of the current frame are correlated to obtain the correlated signal characteristics of the current frame, and the correlated signal characteristics of the current frame are used to decide whether the current frame is a background signal frame, and if the current frame is a background signal frame, the process proceeds to step 103. The updated signal characteristics obtained by updating the signal characteristics of the background signal frame in each embodiment includes characteristic estimation of the background signal frame. In another word, the purpose of updating the signal characteristics of the background signal frame in each embodiment is to estimate the background signal.

Step 103: Detect whether the current frame is in a first type signal state.

The current frame as a background signal frame is detected to detect whether the current frame is in the first type signal state, where the first type signal state may be represented by an adjustment threshold decision parameter. In each embodiment, the music background hangover variable b_mus_hang of the first type signal state is used as an example to describe the adjustment threshold decision parameter. An initial value is preset for the music background hangover variable b_mus_hang, and the change of the music background hangover variable b_mus_hang includes a subtraction operation in the case of deciding that a frame is a background signal frame and a maximization operation in the case of deciding that a frame is a music background frame. A first type signal may be understood as a type of signal among non-speech signals. For example, if a user wishes to receive a speech signal, the first type signal, as compared with a speech, may include noise, music, and so on. In each embodiment, a music signal is taken as an example to describe the first type signal.

Step 104: Adjust a signal classification decision threshold according to whether the current frame is in the first type signal state.

The signal classification decision threshold is adjusted according to whether the current frame is in the first type signal state. When the current frame is in the first type signal state or is not in the first type signal state, different solutions to adjusting the signal classification decision threshold are available. No matter which adjustment solution is used, the signal classification decision thresholds may include multiple thresholds, one or multiple of the thresholds may be selected and adjusted according to different requirements in different application environments. The signal classification decision threshold is used to classify the current frame, and specifically, to classify the signal of the current frame, to determine whether the current frame is a speech frame or a non-speech frame.

In this embodiment, the execution sequence of step 103 and step 104 is not limited. Step 103 and step 104 may be executed before step 102, that is, the decision on whether to adjust the signal classification decision threshold and the adjustment of the signal classification decision threshold may be performed before the decision on whether the current frame is a background signal frame in this embodiment. Further, if the threshold related to the decision on the background signal frame in the signal classification decision threshold is adjusted, that is, the adjusted threshold is used for deciding whether the current frame is a background signal frame, the decision on the background signal frame requires comparison with the signal classification decision threshold, and the signal classification decision threshold depends on the value of the adjustment threshold decision parameter. If step 103 and step 104 are executed before 102, the decision on whether to adjust the threshold and the adjusted threshold may be used in deciding whether the current frame is a background signal frame; otherwise, the decision threshold used in deciding whether the current frame is a background signal frame is a preset threshold or a signal classification decision threshold adjusted and obtained when the background signal frame before the current frame is in the first type signal state.

In each embodiment in the following, both the decision on whether the current frame is in the first type signal state and the adjustment of the signal classification decision threshold may be performed before the signal classification decision threshold is used for the decision on the current frame or performed after the decision on the current frame. The signal classification decision threshold adjusted before the decision on the current frame is used in the decision on the current frame, and the signal classification decision threshold adjusted after the decision on the current frame is used in the decision on subsequent frames, where the decision on the current frame includes the decision on a background signal, decision on a useful signal, and decision on speech and music signals.

### Embodiment 2

### Signal Identifying Method

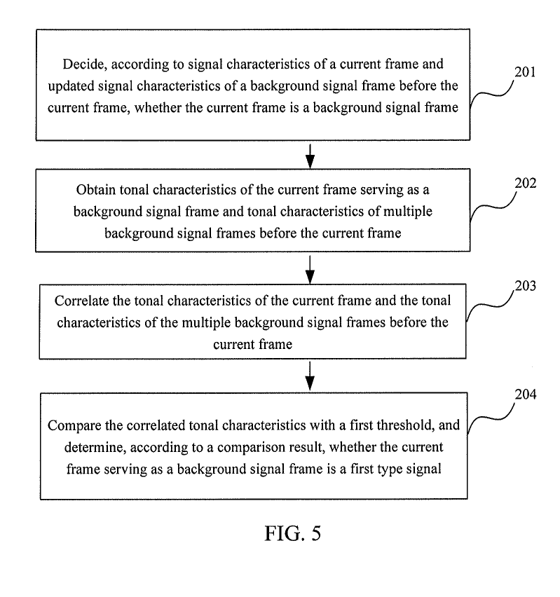

FIG. 5 is a schematic diagram of an embodiment of another signal identifying method, including the following steps:

Step 201: Decide, according to signal characteristics of a current frame and updated signal characteristics of a background signal frame before the current frame, whether the current frame is a background signal frame.

Before the decision on whether the current frame is a background signal frame, a frame that is decided as a background signal frame before the current frame requires the update of the background signal frame, where the update of the background signal frame includes updating the signal characteristics of the background signal frame, for example, performing a moving average operation on long-term characteristic parameters of the background signal frame according to the signal characteristics of the frame to obtain a long-term moving average parameter of the background signal. It may be understood that the characteristic parameters of the current background frame are used to update the long-term average parameter of the background signal. The update of the background signal frame may also include performing windowing or other operations on other parameters of the background signal according to the characteristic parameters of the frame, in addition to the above-mentioned signal characteristic estimation. By taking the long-term moving average parameter as an example, the long-term moving average parameter is correlated with the signal characteristics of the current frame and serves as a basis for deciding whether the current signal frame is a background signal frame. Specifically, the correlated signal characteristics of the current signal frame may be compared with a background/foreground decision threshold T1; if the signal characteristics of the current signal frame are greater than the background/foreground decision threshold T1, the current frame is decided as a background signal frame. The compared background/foreground decision threshold T1 is obtained by the following way: presetting a background/foreground decision threshold, or is obtained through adjustment according to whether the current frame or the background signal frame before the current frame is in the first type signal state, where the obtaining through adjustment according to whether the current frame or the background signal frame before the current frame is in the first type signal state includes adjusting the background/foreground decision threshold by comparing an adjustment threshold decision parameter with a threshold.

Step 202: Obtain tonal characteristics of the current frame serving as a background signal frame and tonal characteristics of multiple background signal frames before the current frame.

The tonal characteristics accumulated for a period may be tonal characteristics of frames including the current frame and multiple background signal frames before the current frame in a set time condition, or may be tonal characteristics of frames including the current frame and multiple background signal frames before the current frame in a set count condition, where the count value may be 3, 100, or more including the current frame and is not limited in this embodiment.

Step 203: Correlate the tonal characteristics of the current frame and the tonal characteristics of the multiple background signal frames before the current frame.

The correlating the tonal characteristics of the current frame and the tonal characteristics of the multiple background signal frames before the current frame includes performing summation, or variation or replacement after summation, or summation after variation or replacement, or form updating after variation or replacement on all the above tonal characteristics to obtain correlated tonal characteristics.

Step 204: Compare the correlated tonal characteristics with a first threshold, and determine, according to a comparison result, whether the current frame as a background signal frame is a first type signal.

The first type signal in the embodiment may include a music signal. Whether the current frame is a music background may be decided according to the comparison result. The step also includes adjusting a signal classification decision threshold according to the comparison result to classify signals of the current frame. If the correlated tonal characteristics are greater than the first threshold, the current frame as a background signal frame is a non-speech background, and a music background is taken as an example for description here. If the correlated tonal characteristics are smaller than or equal to the first threshold, the current frame as a background signal frame is a non-music background. According to the comparison result and corresponding to the music background and non-music background, the signal classification decision threshold may also be adjusted, where the signal classification decision threshold may include the background/foreground decision threshold T1, a useful signal decision threshold T2 or a speech/music decision threshold T3 of a voice activity detector (VAD).

### Embodiment 3

### Signal Identifying Method

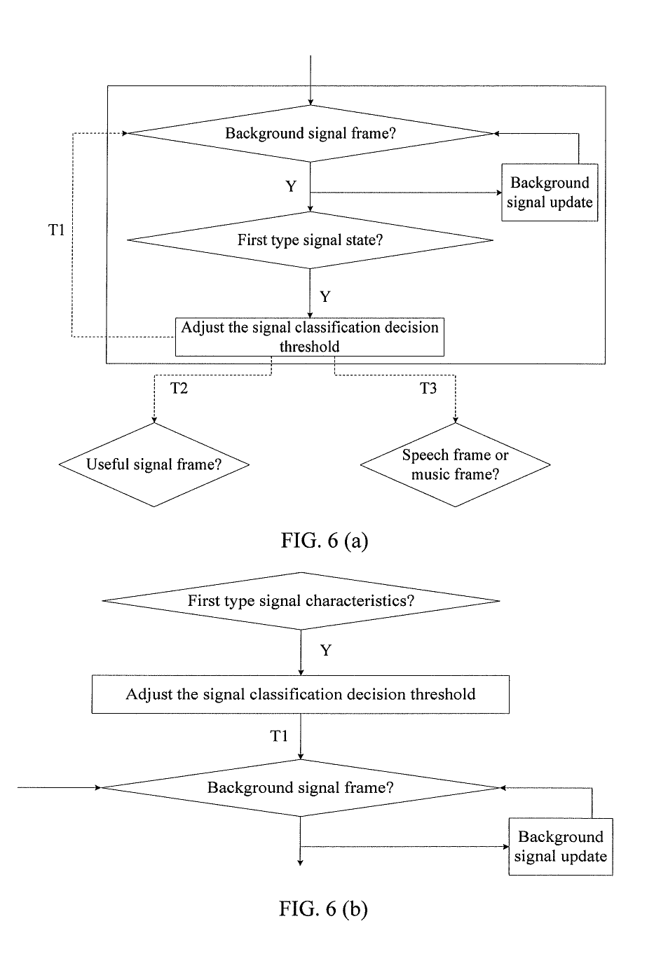

FIG. 6(a) and FIG. 6(b) are schematic diagrams of an embodiment of another signal identifying method, including the following steps:

Obtain signal characteristics of a current frame of input signals.

Whether the current frame is a background signal frame is decided according to the signal characteristics of the current frame and updated signal characteristics of a background signal frame before the current frame. Specifically, the updated signal characteristics of the background signal frame before the current frame and the signal characteristics of the current frame are correlated to obtain the correlated signal characteristics of the current frame, and the correlated signal characteristics of the current frame are compared with a background/foreground decision threshold to decide whether the current frame is a background signal frame. When the correlated signal characteristics of the current frame are greater than the background/foreground decision threshold, the current frame is a background signal frame. The background/foreground decision threshold is obtained by the following way: presetting the background/foreground decision threshold, or is obtained through adjustment according whether the current frame or the background signal frame before the current frame is in a first type signal state. The obtaining the background/foreground decision threshold through adjustment according to whether the background signal frame before the current frame is in the first type signal state includes adjusting the background/foreground decision threshold by comparing an adjustment threshold decision parameter with a threshold, where the adjustment threshold decision parameter is reset when the background signal frame before the current frame is in the first type signal state. The obtaining the background/foreground decision threshold through adjustment according to whether the current frame is in the first type signal state includes comparing the adjustment threshold decision parameter with the threshold to decide which is greater before deciding whether the current frame is a background signal frame, adjusting a signal classification decision threshold, and using an adjustment result as a decision threshold for deciding whether the current frame is a background signal frame.

The background signal of the current frame that is decided as a background signal frame is updated, where the updated background signal is used in deciding whether the subsequent frame is a background signal. A subtraction operation is performed on an adjustment threshold decision parameter value for the current frame that is decided as a background signal frame.

Whether the current frame as a background signal frame is in the first type signal state is detected. Specifically, the adjustment threshold decision parameter is compared with the threshold to decide which is greater and the signal classification decision threshold is adjusted, and an adjustment result is used as a decision threshold for deciding whether the current frame is a background signal frame.

This embodiment further includes: deciding whether the current frame as a background signal frame is background music; obtaining tonal characteristics of the current frame as a background signal frame and tonal characteristics of multiple background signal frames before the current frame; correlating the tonal characteristics of the current frame and the tonal characteristics of the multiple background signal frames before the current frame; performing a counting operation on the multiple background signal frames that are before the current frame and are correlated by a signal characteristic correlating module, and stopping correlating if the correlated counting operation of the current frame reaches a technical preset value; performing a subtraction operation on the adjustment threshold decision parameter value when the signal characteristic correlating module correlates the tonal characteristics of the multiple background signal frames before the current frame, and performing a subtraction operation on the adjustment threshold decision value each time when correlating tonal characteristics of a background signal frame before the current frame.

The correlated tonal characteristics are compared with a first threshold to detect whether the current frame as a background signal frame is a first type signal, namely, a music signal. If the correlated tonal characteristics are greater than the first threshold, the current frame is a music background. In this case, the adjustment threshold decision parameter is reset. Otherwise, the adjustment threshold decision parameter is not changed. Further, the signal classification decision threshold is adjusted by comparing the adjustment threshold decision parameter with the threshold to increase the update ratio of background signals, so that some foreground frames as background frames are updated. The adjusting the signal classification decision threshold includes: adjusting a background/foreground decision threshold, useful signal decision threshold, or speech/music decision threshold.

### Embodiment 4

### Signal Identifying Method

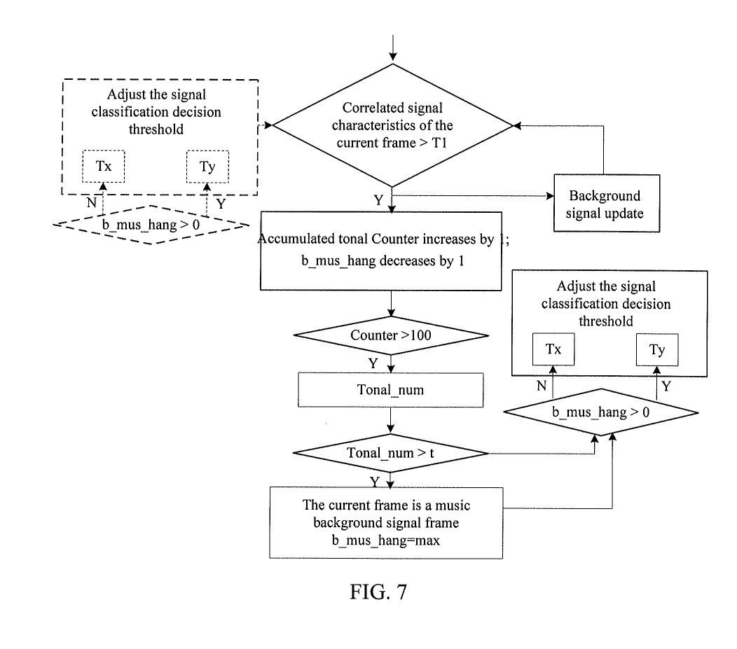

FIG. 7 is a schematic diagram of an embodiment of another signal identifying method. This embodiment exemplifies a specific implementation solution in the signal identifying method. It should be noted that technical parameters, technical values, or names in this embodiment are not intended to limit the present invention, and appropriate variation, modification, or replacement can be made in different application scenarios. The signal identifying method includes the following.

Characteristic parameters of current input signals are extracted, for example, parameters such as signal-to-noise ratio, the operation of adjusting a signal classification decision threshold is performed at this time, as shown in the dashed-line block in FIG. 7, or may also be executed subsequently, and the process of performing adjustment subsequently is described later in this embodiment. Here an adjustment threshold decision parameter needs to be decided for adjusting the signal classification decision threshold, where the adjustment threshold decision parameter has a set initial value and may be presented as a music background hangover variable b_mus_hang. Whether b_mus_hang is greater than 0 is decided. If b_mus_hang is greater than 0, the signal classification decision threshold is adjusted. If a background/foreground decision threshold is adjusted, the background/foreground decision threshold is adjusted to T1x when b_mus_hang is greater than 0, or else, the background/foreground decision threshold is adjusted to T1y. The characteristic parameters are compared with an adjusted background/foreground decision threshold T1 to decide whether the current frame is a useful signal frame or a background signal frame. If the current frame is a background signal, the variable b_mus_hang decreases by 1. When b_mus_hang is smaller than 0, 0 is assigned to b_mus_hang, and a counter increases by 1. The initial value of the counter may be 0. At the same time, whether the current frame has music characteristics is detected. Detecting whether the current frame has music characteristics includes: if the value of the counter in the decision on the current frame reaches a preset value, for example, 100, calculating the tonal characteristic parameter tonal of the current frame, obtaining the tonal parameters of the buffered first 100 background frames including the current frame, and performing summation on the parameters to obtain a tonal_sum parameter, where if tonal_sum is greater than a first threshold t, it indicates that the current frame is a music background, and the music background hangover variable b_mus_hang is set to max. In this embodiment, t is set to 1200, and max is set to 1000.

Further, the signal classification decision threshold can be adjusted, and whether b_mus_hang is greater than 0 is decided, and a signal classification decision threshold T1, T2, or T3 is adjusted. When T1 is adjusted, if b_mus_hang is greater than 0, the signal classification decision threshold is T1x, or else, the signal classification decision threshold is T1y; when T2 is adjusted, if b_mus_hang is greater than 0, the signal classification decision threshold is T2x, or else, the signal classification decision threshold is T2y; when T3 is adjusted, if b_mus_hang is greater than 0, the signal classification decision threshold is T3x, or else, the signal classification decision threshold is T3y.

If the current frame is decided as a background signal frame above, a background signal is updated, for example, a moving average operation is performed on the long-term characteristic parameters of the background signal according to the characteristic parameters of the current frame to obtain a long-term moving average parameter. The long-term moving average parameter may be used in the decision on whether a subsequent frame is a background signal frame or a useful signal frame when the current frame is a background frame. In the process of deciding whether the current frame is a background signal frame or a useful signal frame, the characteristic parameters of the current frame that are compared with the background/foreground decision threshold are also correlated with background signal update information of a background signal frame before the current frame. Taking the long-term moving average parameter as an example, a moving average operation is performed on the long-term characteristic parameters of several frames before and after the background signal according to the characteristic parameters of frames to obtain a long-term moving average parameter. The moving average parameter is correlated with the characteristic parameters of the current frame to obtain a correlated characteristic parameter of the current frame. The correlated characteristic parameter of the current frame is compared with T1 to decide whether the current frame is a background signal frame.

Unless otherwise specified, in each embodiment in the following, the background signal frame before the current frame is described by using a previous background signal frame as an example, and a subsequent frame is described by using a next frame as an example, that is, the frame before the current frame or the frame after the current frame is described by using a previous frame or next frame respectively.

### Embodiment 5

### Signal Classifying Method

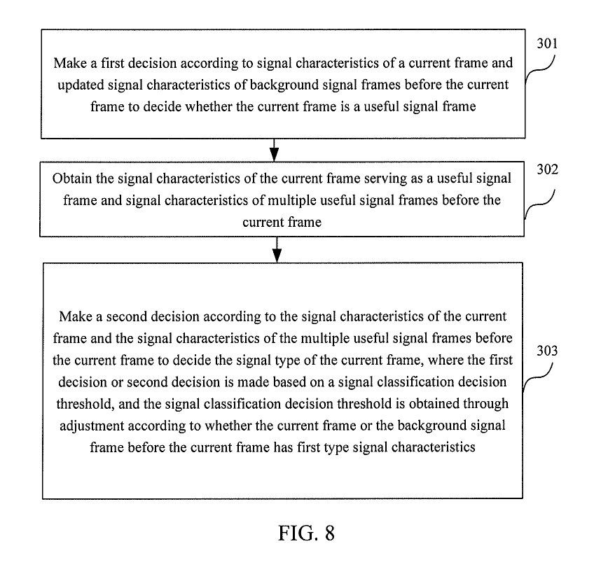

FIG. 8 is a schematic diagram of an embodiment of a signal classifying method, including the following steps:

Step 301: Make a first decision according to signal characteristics of a current frame and updated signal characteristics of multiple background signal frames before the current frame to decide whether the current frame is a useful signal frame.

Input signals are divided into frames, and the signal frames after division are used as processed objects to obtain signal characteristics of the current frame. The updated signal characteristics of the background signal of a previous background signal frame are received or actively obtained. The updated signal characteristics of the background signal are correlated with the signal characteristics of the current frame, and the correlated signal characteristics of the current frame are used as a basis for deciding whether the current frame is a useful signal frame. The correlated signal characteristics of the current frame, used as parameters, are compared with a useful signal decision threshold T2. Whether the current frame is a useful signal is decided according to a comparison result, and if the current frame is a useful signal, step 302 is executed.

Step 302: Obtain the signal characteristics of the current frame serving as a useful signal frame and signal characteristics of multiple useful signal frames before the current frame.

The result obtained in step 301, that is, whether the current frame is a useful signal, decides whether to accumulate the signal characteristic parameters of the frame. If the signal is a useful signal, the signal characteristics of the current frame and the signal characteristics of the multiple useful signal frames before the current frame are obtained. Specifically, the characteristic parameters of the frame may be buffered in an array. In this embodiment, characteristic parameters of the first multiple useful signal frames including the current frame are buffered. Otherwise, the characteristic parameters of the first multiple useful signal frames including the current frame are not buffered.

Step 303: Make a second decision according to the signal characteristics of the current frame and the signal characteristics of the multiple useful signal frames before the current frame to decide the signal type of the current frame, where the first decision or second decision is made based on a signal classification decision threshold, and the signal classification decision threshold is obtained through adjustment by deciding that the previous background signal frame is in a first type signal state.

During the decision, buffered signal characteristics, which may be used as characteristic parameters, are compared with a speech/music decision threshold T3 one by one. The signal type of the current frame is decided as a speech frame or music frame signal according to a comparison result.

In step 301 and step 303, one of the useful signal decision threshold and the speech/music decision threshold uses the signal classification decision threshold adjusted and obtained when a previous music background signal frame is decided. A preset threshold value, an empirical threshold value, or a threshold used in a previous decision is used for one of the useful signal decision threshold and the speech/music decision threshold, where one of the useful signal decision threshold and the speech/music decision threshold does not use the signal classification decision threshold; and in some circumstances, even a random threshold value may be used, which is not limited here. For whether the adjusted threshold value or other threshold values are used, the signal classification decision threshold needs to be searched when the signal classification decision threshold is used. If the signal classification decision threshold value is adjusted in the signal identification of a previous frame, the adjusted signal classification decision threshold is used; otherwise, other threshold value information is used. In another circumstance, the signal classification decision threshold may be adjusted before the first or second decision. Whether a current adjustment threshold decision parameter is greater than a threshold is decided and the signal classification decision threshold is adjusted accordingly.

In another implementation condition, it is unnecessary to change one of the useful signal decision threshold and speech/music decision threshold to the adjusted signal classification decision threshold, but the background/foreground decision threshold used in the background signal decision in the signal identifying method is changed to the adjusted signal classification decision threshold, which may also reach the same technical effect.

### Embodiment 6

### Signal Classifying Method

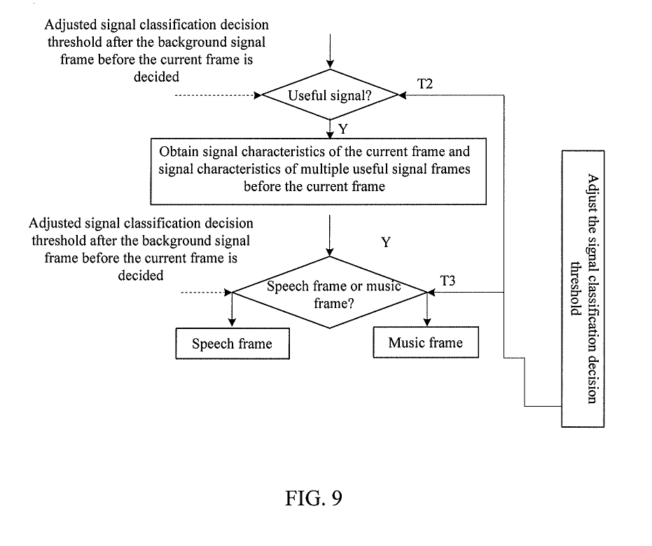

FIG. 9 is a schematic diagram of an embodiment of a signal classifying method, including the following steps:

A first decision is made according to signal characteristics of a current frame and updated signal characteristics of a background signal frame before the current frame to decide whether the current frame is a useful signal frame. Specifically, the updated signal characteristics of the background signal frame before the current frame are correlated with the signal characteristics of the current frame to obtain the correlated signal characteristics of the current frame, and a first decision is made with respect to the correlated signal characteristics of the current frame and a useful signal decision threshold to decide whether the current frame is a useful signal frame.

When the correlated signal characteristics of the current frame are greater than the useful signal decision threshold, the current frame is decided as a useful signal frame. Because a part of the useful signal frames as background signal frames are updated during signal identification, the level of a background signal is increased, but the level of a foreground signal is not changed. Therefore, the signal-to-noise ratio of the background signal in the decision of the voice activity detector on the useful signal frame is decreased, thereby causing a part of non-speech frames not to be decided as useful signals.

Signal characteristics of the current frame as a useful signal frame and signal characteristics of multiple useful signal frames before the current frame are obtained.

A second decision is made according to the signal characteristics of the current frame and the signal characteristics of the multiple useful signal frames before the current frame to decide the signal type of the current frame. Specifically, the signal characteristics of the multiple useful signal frames including the current frame are compared with a speech/music decision threshold; if the number of frames with the signal characteristics greater than or equal to the speech/music decision threshold is greater than the number of frames with the signal characteristics smaller than the speech/music decision threshold, the current frame is decided as a speech frame; otherwise, the current frame is decided as a first type signal frame.

The first decision or second decision is made based on a signal classification decision threshold. The signal classification decision threshold is obtained through adjustment according to whether the current frame or the background signal frame before the current frame is in a first type signal state. Specifically, the signal classification decision threshold may be obtained by adjusting a background/foreground decision threshold by comparing an adjustment threshold decision parameter with a threshold. A subtraction operation is performed on the adjustment threshold decision parameter when the current frame is decided as a background signal frame, and the adjustment threshold decision parameter is reset when the background signal frame before the current frame is in the first type signal state. The adjusting the signal classification decision threshold includes: adjusting a background/foreground decision threshold, useful signal decision threshold, or speech/music decision threshold.

### Embodiment 7

### Signal Classifying Method

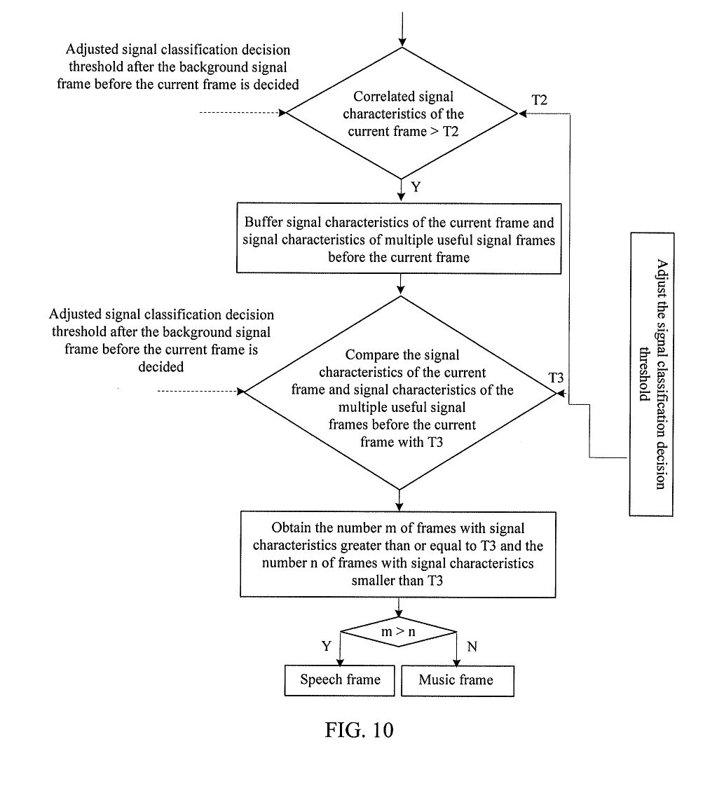

FIG. 10 is a schematic diagram of an embodiment of another signal classifying method. This embodiment exemplifies a specific implementation solution in the signal identifying method. It should be noted that technical parameters, technical values, names or others in this embodiment are not intended to limit the present invention, and appropriate variation, modification, or replacement can be made in different application scenarios. The signal classifying method includes the following.

Characteristic parameters of signals of each frame are extracted. Whether a current frame is a useful signal is decided according to the characteristic parameters of the current frame. That is, the characteristic parameters of the current frame are compared with a useful signal decision threshold T2, and the characteristic parameters of the current frame are correlated with updated signal characteristics of multiple useful signal frames before the current frame, where the useful signal decision threshold is obtained by adjusting a signal classification decision threshold. In the process of identifying the current frame or a background signal frame before the current frame, the signal classification decision threshold is adjusted according to the comparison result of an adjustment threshold decision parameter b_mus_hang and the value 0. During the adjustment of the useful signal decision threshold T2, the adjusted useful signal decision threshold is used in the signal classifying method as a decision threshold for deciding whether the current frame signal is a useful signal. When the characteristic parameters of the current frame are greater than the adjusted useful signal decision threshold T2, the current frame is a useful signal, and whether the current frame is a useful signal determines whether to accumulate the signal characteristic parameters of the frame. If the signal is a useful signal, the characteristic parameters of the frame are buffered in an array, and in the embodiment, characteristic parameters of the first 120 foreground frames including the current frame a re buffered; otherwise, the characteristic parameters of the frames are not buffered. During the decision, the buffered characteristic parameters are compared with a speech/music decision threshold one by one. The speech/music decision threshold uses a preset threshold and the number m of frames greater than or equal to the threshold and the number n of frames smaller than the threshold in the buffered parameters are calculated; when m is greater than n, the current frame is decided as a speech frame, and otherwise, the current frame is decided as a music frame. A characteristic parameter value is greater, indicating that the frame has speech characteristics and the current frame is a speech frame; otherwise, indicating that the current frame has music characteristics and the current frame is a music frame. Because the useful signal decision threshold is adjusted in the current frame or the background signal frame before the current frame, a part of music frames are not decided as useful signals in the decision on the useful signal frames. Therefore, the characteristic parameters of a part of the music frames are not buffered. In the calculation of m and n, the number of frames smaller than the speech/music decision threshold is decreased and the identification ratio of speech signals is further increased.

### Embodiment 8

### Signal Processing System

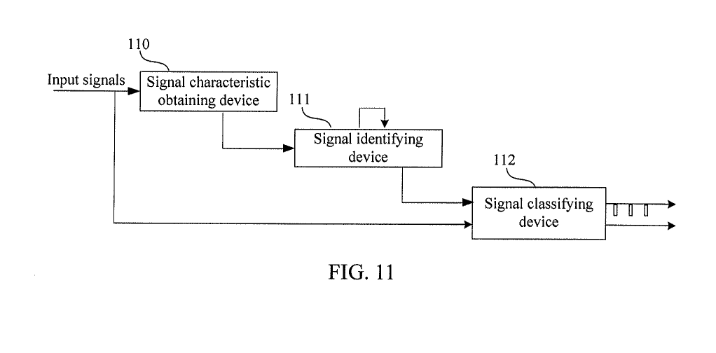

FIG. 11 is a schematic diagram of an embodiment of a signal processing system, including:

a signal characteristic obtaining device, configured to obtain signal characteristics of a current frame of input signals.

A signal identifying device is further included, and is configured to detect, according to the signal characteristics of the current frame, whether the current frame is a background signal frame, and adjust a signal classification decision threshold according to whether the current frame is in a first type signal state.

The signal identifying device decides, according to the signal characteristics of the current frame, whether the current frame is a background signal frame. The decision includes: comparing the signal characteristics of the current frame that are correlated with updated signal characteristics of a background signal frame before the current frame with a background/foreground decision threshold; when the signal characteristics of the current frame correlated with the updated signal characteristics of the background signal frame before the current frame are greater than the background/foreground decision threshold, deciding that the current frame is a background signal frame; obtaining tonal characteristics of the current frame as a background signal frame and tonal characteristics of multiple background signal frames before the current frame, and correlating the tonal characteristics of the current frame with the tonal characteristics of the multiple background signal frames before the current frame; when the count of correlated frames reaches a preset count value, comparing the correlated tonal characteristics with a first threshold, and when the correlated tonal characteristics are greater than the first threshold, deciding that the background signal frame is a music background signal; if an adjustment threshold decision parameter is greater than a preset threshold, adjusting the signal classification decision threshold, where the adjusting the signal classification decision threshold includes adjusting a background/foreground decision threshold T1, useful signal decision threshold T2 or speech/music decision threshold T3 of a voice activity detector (VAD). The adjusted signal classification decision threshold is used in the background signal decision, useful signal decision, or speech/music classification decision of a subsequent frame. For example, if the background/foreground decision threshold is adjusted for the current frame, when the adjusted background/foreground decision threshold is used in the background signal decision of a next frame, the background/foreground decision threshold used in the decision and comparison on whether the next frame is a background signal frame is an adjusted T1 of the current frame in the signal identifying device. The comparison of the adjustment threshold decision parameter may also be performed before the decision on whether the current frame is a background signal, when the adjusted background/foreground decision threshold is used in deciding whether the current frame is a background signal frame.

A signal classifying device is further included, and is configured to decide, according to the signal characteristics of the current frame, whether the current frame is a useful signal frame, and decide the signal type of the current frame serving as a useful signal frame, where the decision on whether the current frame is a useful signal frame or the decision on the signal type of the current frame serving as a useful signal frame is made based on a signal classification decision threshold, where the signal classification decision threshold is obtained through adjustment according to whether the current frame or a background signal frame before the current frame is in a first type signal state.

The signal classifying device makes a first decision according to the signal characteristics of the current frame and updated signal characteristics of multiple background signal frames before the current frame to decide whether the current frame is a useful signal frame; obtains the signal characteristics of the current frame as a useful signal frame and signal characteristics of multiple useful signal frames before the current frame; and makes a second decision, according to the signal characteristics of the current frame and the signal characteristics of the multiple useful signal frames before the current frame, to decide the signal type of the current frame and differentiate a speech frame and a music frame in the input signals. The first decision or second decision is made based on the signal classification decision threshold, where the signal classification decision threshold is obtained through adjustment according to whether the current frame or the background signal frame before the current frame is in a first type signal state. Whether the signal classification decision threshold is used in the first decision or the second decision depends on which threshold information is adjusted in the adjustment of the signal classification decision threshold in the current frame or in a frame before the current frame. For example, if a useful signal decision threshold is adjusted, the signal classifying device compares the signal characteristics of the current frame that are correlated with the updated signal characteristics of multiple background signal frames before the current frame with the adjusted useful signal decision threshold to decide whether the current frame is a useful signal frame.

### Embodiment 9

### Signal Processing System

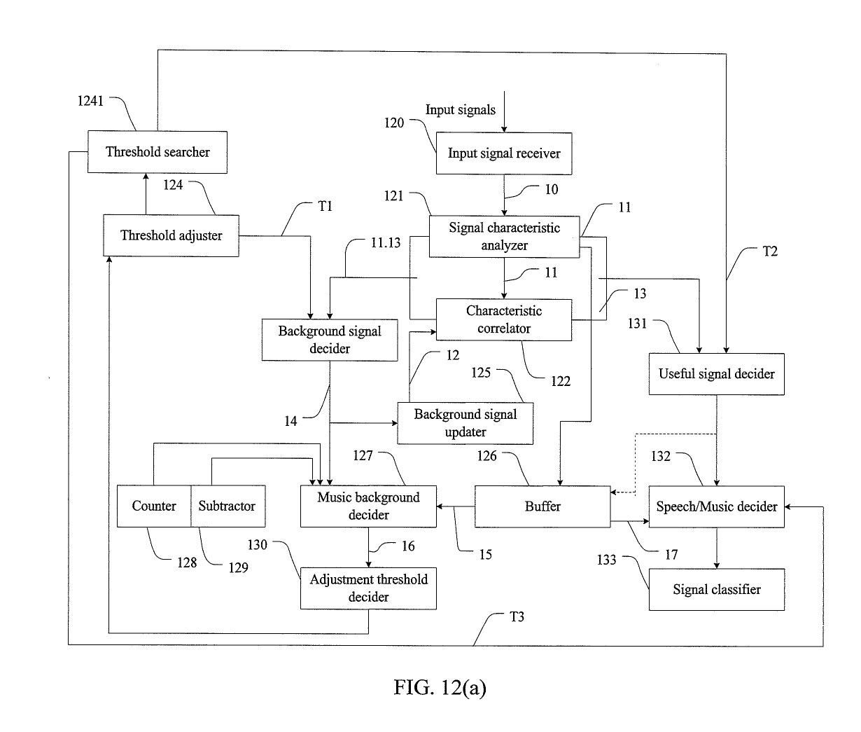

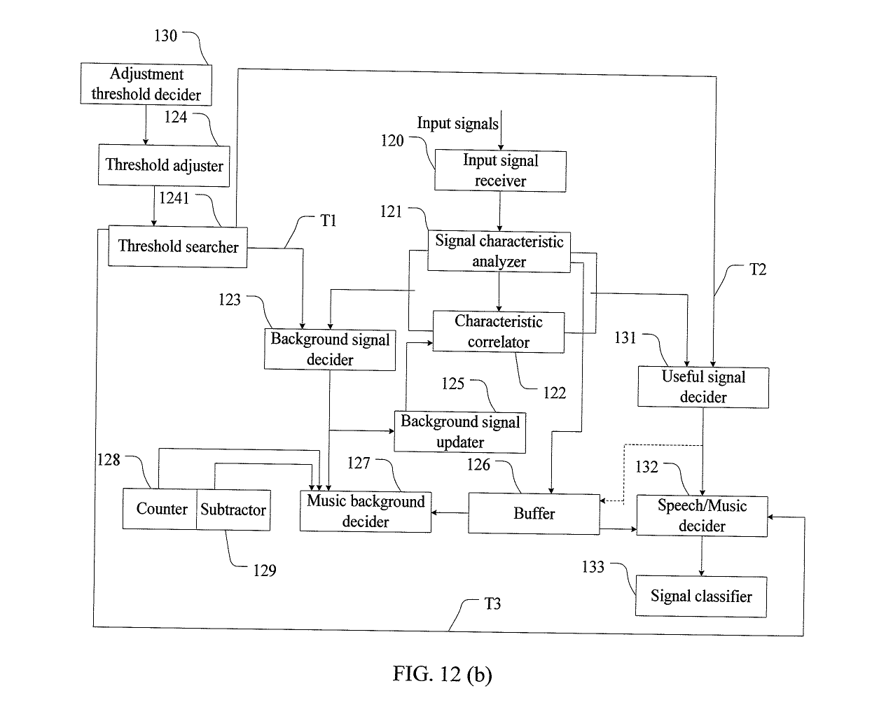

FIG. 12(a) and FIG. 12(b) are schematic diagrams of an embodiment of a signal processing system, including an input signal receiver 120. The input signal receiver receives input signals; divides the input signals into frames to obtain N signal frames 10, where N is a natural number; and processes each signal frame, where a processed current signal frame is called a current frame. The input signal receiver sends the signal frames after the dividing to a signal characteristic analyzer 121 one by one, and the signal characteristic analyzer 121 analyzes the current frame, extracts characteristic parameters of the current frame, such as a signal-to-noise ratio parameter, and sends the extracted signal-to-noise ratio parameter 11 to a characteristic correlator 122. A background/foreground decision threshold T1 is sent to a background signal decider 123, where the background/foreground decision threshold is provided by a signal threshold adjuster 124. When a threshold searcher 1241 searches a signal frame decision threshold in the threshold adjuster to find that the background/foreground decision threshold of the current frame or a previous background signal frame is not adjusted, a preset threshold or a threshold value used in the previous decision is used, or a threshold is provided by the system at random. When the background/foreground decision threshold is adjusted in the previous frame processing or the threshold value is adjusted in the current frame, the threshold sent to the background signal decider in the current frame processing is a background/foreground decision threshold adjusted in the previous frame processing or a background/foreground decision threshold adjusted in the current frame. Characteristic correlation is performed on the signal-to-noise ratio parameter in the characteristic correlator before the signal-to-noise ratio parameter is sent to the background signal decider. The characteristic correlator receives the characteristic parameters of the current frame, and correlates the characteristic parameters with background signal update information 12 obtained after the previous background signal frame decision to form a correlated characteristic parameter 13 of the current frame, for example, correlates a long-term moving average parameter, which is obtained by performing a moving average operation on long-term characteristic parameters of a background signal according to the characteristic parameters of the previous frame, with the characteristic parameters of the current frame to form a correlated characteristic parameter of the current frame, where the background signal update information after the previous background signal frame decision comes from a background signal updater 125. The correlated characteristic parameter of the current frame is sent to the background signal decider, and the background signal decider compares the correlated characteristic parameter of the current frame with the background/foreground decision threshold. When the characteristic parameter of the current frame is greater than the background/foreground decision threshold, the current frame is decided as a background signal frame. A decision result 14 is sent to a music background decider, and the sum value of the tonal characteristics of the first 100 background frames including the current frame and a decision threshold 15 are also sent to the music background decider 127, where the first 100 background frames including the current frame are buffered in a buffer 126, and the tonal parameters can also be obtained through the signal characteristic analyzer 121. The system further includes a counter 128 which performs a counting operation on the first 100 background frames including the current frame, and also includes a subtractor 129 which performs a subtraction operation on the music background hangover variable b_mus_hang. Each time when a signal frame is processed, the counter increases by 1, and b_mus_hang decreases by 1; when the counter reaches 100, the sum value tonal_sum of the tonal is calculated. If the current frame is the 100^{th} frame counted by the counter, the music background decider compares tonal_sum with the decision threshold. If tonal_sum is greater than a preset decision threshold, it indicates that the current frame is a music background, and the music background hangover variable b_mus_hang is set to max; if tonal_sum is not greater than a preset decision threshold, b_mus_hang does not change. In this embodiment, T=1200, and max=1000. Further, the signal classification decision threshold may be adjusted. The result 16 of b_mus_hang is sent to an adjustment threshold decider 130. When b_mus_hang is greater than 0, the threshold adjuster 124 adjusts the signal classification decision threshold to a first threshold, or else, adjusts the signal classification decision threshold to a second threshold. The adjusting the first or second threshold 17 includes adjusting a background/foreground decision threshold T1, useful signal decision threshold T2, or speech/music decision threshold T3. If the adjusting of the signal classification decision threshold is performed before the signals enter the background signal decider, the adjustment threshold decider first decides whether b_mus_hang is greater than 0. The threshold adjuster adjusts the signal classification decision threshold according to a decision result. At this time, the threshold searcher searches the background/foreground decision threshold, and sends the background/foreground decision threshold to the background signal decider if the background/foreground decision threshold is adjusted, as shown in FIG. 12(b). The above components may be integrated into a background detector.

The input signals are divided by the input signal receiver into frames, analyzed by the signal characteristic analyzer, and correlated by the characteristic correlator to form a correlated characteristic parameter of the current frame, which is also sent to a useful signal decider 131. The useful signal decision threshold from the threshold adjuster is also sent to the useful signal decider. When the threshold searcher 1241 searches the signal frame decision threshold to find that the useful signal decision threshold of the previous background signal frame is not adjusted in the previous frame processing, a preset threshold is used or a threshold value in the previous decision is used, or a threshold is provided by the system at random. When the useful signal decision threshold is adjusted in the previous frame processing, the threshold sent to the useful signal frame decider in the current frame processing is a useful signal decision threshold adjusted in the previous frame processing. The useful signal decider compares the useful signal decision threshold with the correlated characteristic parameter of the current frame. If the correlated characteristic parameter of the current frame is greater than the useful signal decision threshold, the current frame is decided as a useful signal frame. When the current frame is a useful signal frame, the characteristic parameters of the current frame are buffered by the buffer 126 into an array, and in the embodiment, the characteristic parameters 17 of the first 120 useful signal frames including the current frame are buffered. The buffered characteristic parameters are sent to a speech/music decider 132, and the speech/music decision threshold from the threshold adjuster is also sent to the speech/music decider at the same time. When the threshold searcher 1241 searches the signal frame decision threshold to find that the speech/music decision threshold of the previous background signal frame is not adjusted in the previous frame processing, a preset threshold is used or a threshold value in the previous decision is used, or a threshold is provided by the system at random. When the speech/music decision threshold is adjusted in the previous frame processing, the threshold sent to the background signal decider in the current frame processing is a speech/music decision threshold adjusted in the previous frame processing. The speech/music decider compares the buffered characteristic parameters with the speech/music decision threshold one by one. A signal classifier 133 calculates the number m of frames greater than or equal to the threshold and the number n of frames smaller than the threshold in the buffered parameters according to the comparison result of the speech/music decider. When m is greater than n, the current frame is classified into a speech frame; otherwise, the current frame is classified into a music frame. A characteristic parameter value is greater, indicating that the frame has speech characteristics; otherwise, indicating that the frame has music characteristics. The useful signal decision threshold or speech/music decision threshold used above uses the adjustment result of a previous frame, and may also be obtained by the adjustment threshold decider and threshold adjuster according to the current threshold adjustment decision parameter and sent to the useful signal decider or speech/music decider, before the signals are sent to the useful signal decider or speech/music decider, as shown in FIG. 12(b). The above components may be integrated into a speech/music classifier. The component required for deciding a useful signal frame may also be independent of the speech/music classifier and serve as a voice activity detector. The background detector and speech/music classifier may also share an input signal receiver, a signal characteristic analyzer, or a characteristic correlator, or a buffer.

### Embodiment 10

### Signal Identifying Device

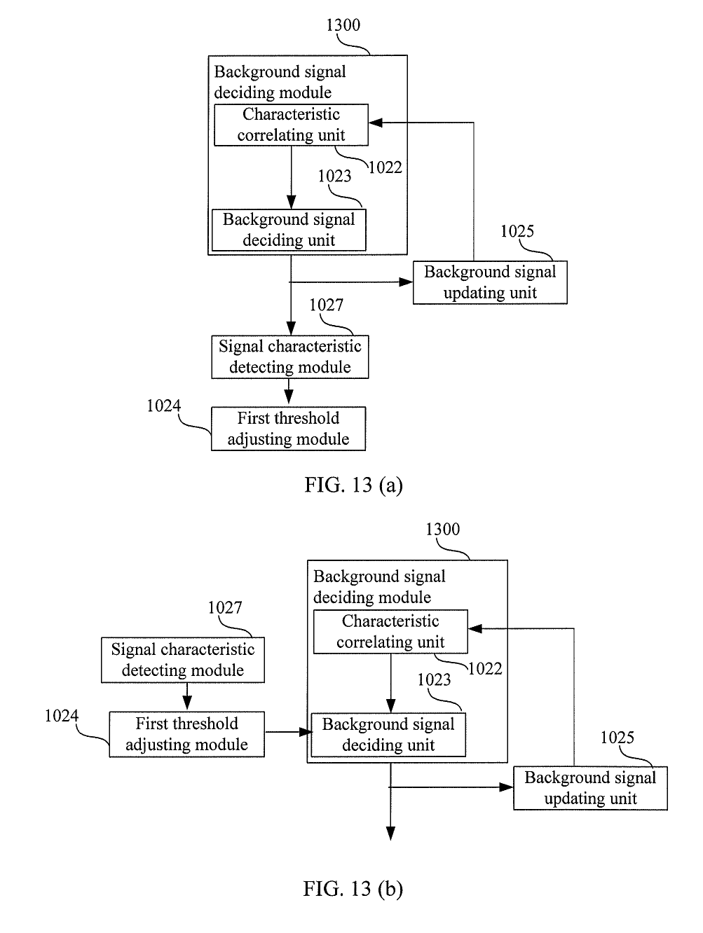

FIG. 13(a) and FIG. 13(b) are schematic diagrams of an embodiment of a signal identifying device, including:

a background signal deciding module 1300, configured to decide, according to signal characteristics of a current frame and updated signal characteristics of a background signal frame before the current frame, whether the current frame is a background signal frame. The background signal deciding module obtains the signal characteristics of the current frame and the updated signal characteristics of the background signal frame before the current frame, and correlates the signal characteristics of the current frame and the updated signal characteristics of the background signal frame before the current frame to obtain correlated signal characteristics. The signal characteristics are compared with a background/foreground decision threshold, where the background/foreground decision threshold includes preset threshold values, such as an empirical value and a random value, or includes the value of the background/foreground decision threshold adjusted in adjusting the signal classification decision threshold of a previous frame.

The signal identifying device further includes a signal characteristic detecting module 1027, configured to detect whether the current frame is in a first type signal state. Specifically, the signal identifying device is configured to decide, by comparing a threshold adjustment decision parameter of the current frame with a threshold, whether the current frame is in the first type signal state.

The signal identifying device further includes a first threshold adjusting module 1024, configured to adjust the signal classification decision threshold according to whether the current frame as a background frame is in the first type signal state. The adjusting the signal classification decision threshold includes adjusting a background/foreground decision threshold T1, useful signal decision threshold T2, or speech/music decision threshold T3. In the decision on each subsequent frame, the adjusted signal classification decision threshold is used in the background/foreground signal decision, useful signal decision, or speech/music signal decision.

The signal identifying device further includes a background signal updating unit 1025, configured to update the background signal of the current frame that is decided by the background signal deciding unit as a background signal frame, where the updated background signal is used by the background signal deciding unit for deciding whether a subsequent frame is a background signal.

The background signal deciding module includes a characteristic correlating unit 1022, configured to correlate the updated signal characteristics of the background signal frame before the current frame with the signal characteristics of the current frame to obtain the correlated signal characteristics of the current frame; and a background signal deciding unit 1023, configured to compare the correlated signal characteristics of the current frame with the background/foreground decision threshold to decide whether the current frame is a background signal frame.

The background/foreground decision threshold compared in the background signal deciding unit is obtained by the following way: presetting a background/foreground decision threshold, or is obtained through adjustment according to whether the current frame or the background signal frame before the current frame is in the first type signal state. The adjusting of the background/foreground decision threshold according to whether the current frame is in the first type signal state is shown in FIG. 13(b).

### Embodiment 11

### Signal Identifying Device

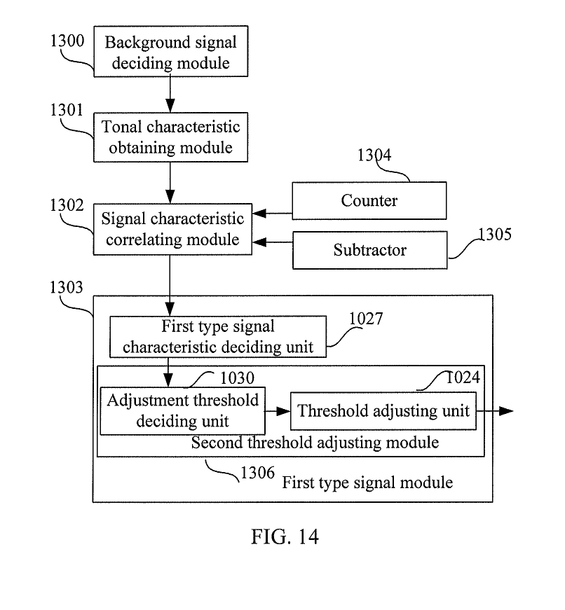

FIG. 14 is a schematic diagram of an embodiment of another signal identifying device, including:

a background signal deciding module 1300, configured to decide, according to signal characteristics of a current frame and updated signal characteristics of a background signal frame before the current frame, whether the current frame is a background signal frame.

The signal identifying device further includes a tonal characteristic obtaining module 1301, configured to obtain tonal characteristics of the current frame serving as a background signal frame and tonal characteristics of multiple background signal frames before the current frame.

The signal identifying device further includes a signal characteristic correlating module 1302, configured to correlate the tonal characteristics of the current frame and the tonal characteristics of the multiple background signal frames before the current frame.

The signal identifying device further includes a first type signal module 1303, configured to compare the correlated tonal characteristics with a first threshold, and determine, according to a comparison result, whether the current frame as a background signal frame is a first type signal.

The signal identifying device further includes a second threshold adjusting module 1306, configured to adjust a signal classification decision threshold according to the comparison result to classify signals of the current frame, including adjusting a background/foreground decision threshold, a useful signal decision threshold, or a speech/music decision threshold.

The signal identifying device further includes a counter 1304, configured to perform a counting operation on the multiple background signal frames before the current frame that are correlated by the signal characteristic correlating module; and a subtractor 1305, configured to perform a subtraction operation on an adjustment threshold decision parameter value when the signal characteristic correlating module correlates the tonal characteristics of the multiple background signal frames before the current frame.

The second threshold adjusting module may be integrated into the first type signal module. In this case, the first type signal module includes: a first type signal characteristic deciding unit 1027, configured to compare the correlated tonal characteristics with the first threshold to determine an adjustment threshold decision parameter; an adjustment threshold deciding unit 1030, configured to compare the adjustment threshold decision parameter with the threshold; and a threshold adjusting unit 1024, configured to adjust the signal classification decision threshold according to the comparison result of the adjustment threshold deciding unit. If the output of the second threshold adjusting module serves as the input of the background signal deciding module, the second threshold adjusting module includes an adjustment threshold deciding unit 1030, configured to compare the adjustment threshold decision parameter with the threshold; a threshold adjusting unit 1024, configured to adjust the signal classification decision threshold according to the comparison result of the adjustment threshold deciding unit, and send the background/foreground decision threshold in the signal classification decision threshold to the background signal deciding module.

### Embodiment 12

### Signal Classifying Device

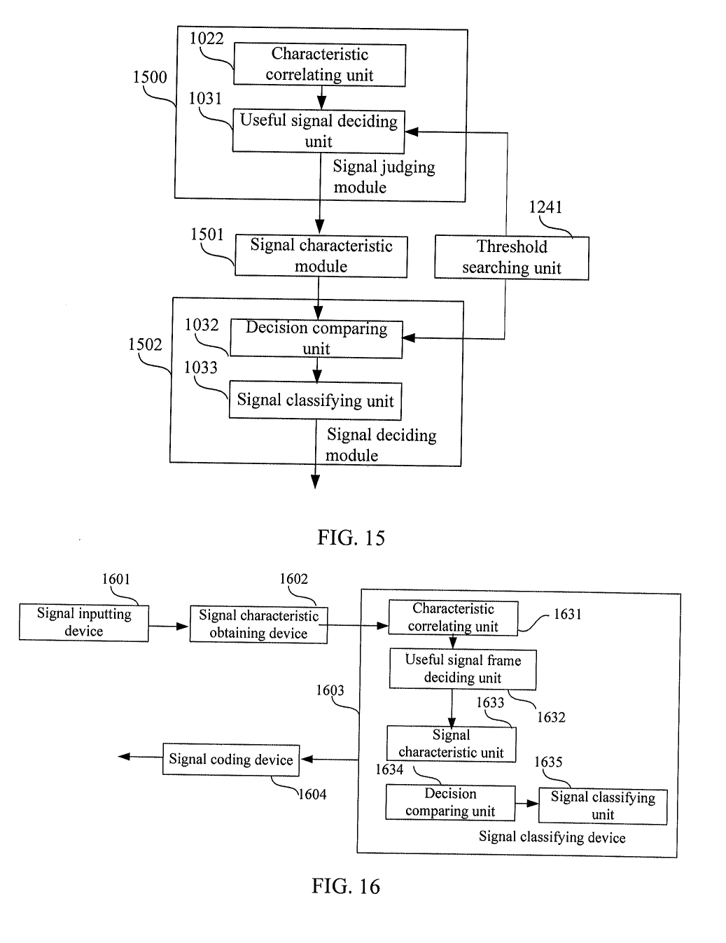

FIG. 15 is a schematic diagram of an embodiment of a signal classifying device, including:

a signal judging module, configured to make a first decision according to signal characteristics of a current frame and updated signal characteristics of multiple background signal frames before the current frame to decide whether the current frame is a useful signal frame.

The signal classifying device further includes a signal characteristic module, configured to obtain the signal characteristics of the current frame serving as a useful signal frame and the signal characteristics of the multiple background signal frames before the current frame.

The signal classifying device further includes a signal deciding module, configured to make a second decision according to the signal characteristics of the current frame and the signal characteristics of the multiple background signal frames before the current frame to decide the signal type of the current frame, where the first decision or second decision is made based on a signal classification decision threshold, where the signal classification decision threshold is obtained through adjustment according to whether the current frame or a background signal frame before the current frame is in a first type signal state, and the adjusting includes adjusting a background/foreground decision threshold, a useful signal decision threshold, or a speech/music decision threshold. The obtaining the signal classification decision threshold through adjustment according to whether the current frame or the background signal frame before the current frame is in the first type signal state includes: obtaining the signal classification decision threshold by adjusting the background/foreground decision threshold by comparing an adjustment threshold decision parameter with a threshold, where the adjustment threshold decision parameter is reset when the current frame or the background signal frame before the current frame is in the first type signal state.

The signal judging module includes a characteristic correlating unit, configured to correlate the updated signal characteristics of the background signal frame before the current frame with the signal characteristics of the current frame to obtain the correlated signal characteristics of the current frame; and a useful signal frame deciding unit, configured to make a first decision with respect to the correlated signal characteristics of the current frame and the useful signal decision threshold to decide whether the current frame is a useful signal frame, where the useful signal decision threshold of the useful signal frame deciding unit includes a preset useful signal decision threshold or is obtained through adjustment according whether a previous background signal frame is in the first type signal state.

The signal classifying device further includes a threshold searching unit, configured to search a signal frame decision threshold to find whether the useful signal decision threshold of the previous background signal frame is adjusted. If the useful signal decision threshold of the previous background signal frame is adjusted, the useful signal frame deciding unit compares the adjusted useful signal decision threshold with the correlated signal characteristics of the current frame; otherwise, the useful signal frame deciding unit compares a preset useful signal decision threshold with the correlated signal characteristics of the current frame.

The signal deciding module includes a decision comparing unit, configured to compare the signal characteristics of multiple useful signal frames including the current frame with the speech/music decision threshold; and a signal classifying unit, configured to decide that the current frame is a speech frame if the number of frames with the signal characteristics greater than or equal to the speech/music decision threshold is greater than the number of frames with the signal characteristics smaller than the speech/music decision threshold, or otherwise, decide that the current frame is a first type signal frame.

### Embodiment 13

### Audio Signal Coding System

FIG. 16 is a schematic diagram of an embodiment of an audio signal coding system, including:

a signal inputting device 1601, configured to receive audio signals;

a signal characteristic obtaining device 1602, configured to obtain signal characteristics of a current frame of audio signals;

a signal classifying device 1603, configured to decide, according to the signal characteristics of the current frame, whether the current frame is a useful signal frame, and decide the signal type of the current frame serving as a useful signal frame, where the decision on whether the current frame is a useful signal frame or the decision on the signal type of the current frame serving as a useful signal frame is made based on a signal classification decision threshold, and the signal classification decision threshold is obtained through adjustment according to whether the current frame or a background signal frame before the current frame is in a first type signal state; and

a signal coding device 1604, configured to use, according to the signal type of the current frame serving as a useful signal frame, a coder to perform coding for different types of signals to obtain coded bit streams of different types of signals.

The signal classifying device includes a characteristic correlating unit 1631, configured to correlate the updated signal characteristics of the background signal frame before the current frame with the signal characteristics of the current frame to obtain the correlated signal characteristics of the current frame; a useful signal frame deciding unit 1632, configured to make a first decision with respect to the correlated signal characteristics of the current frame and a useful signal decision threshold to decide whether the current frame is a useful signal frame; a signal characteristic unit 1633, configured to obtain the signal characteristics of the current frame serving as a useful signal frame and the signal characteristics of multiple useful signal frames before the current frame; a decision comparing unit 1634, configured to compare the signal characteristics of the multiple useful signal frames including the current frame with a speech/music decision threshold; and a signal classifying unit 1635, configured to decide that the current frame is a speech frame if the number of frames with the signal characteristics greater than the speech/music decision threshold is greater than the number of frames with the signal characteristics smaller than the speech/music decision threshold, or otherwise, decide that the current frame is a first type signal frame, where the useful signal decision threshold or speech/music decision threshold is obtained from a threshold adjusting unit.

### Embodiment 14

### Signal Deciding Method

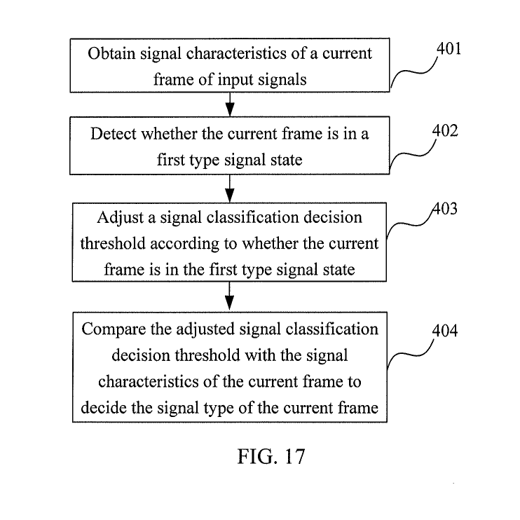

FIG. 17 is a schematic diagram of an embodiment of a signal deciding method, including the following steps:

Step 401: Obtain signal characteristics of a current frame of input signals.

Step 402: Detect whether the current frame is in a first type signal state.

Step 403: Adjust a signal classification decision threshold according to whether the current frame is in the first type signal state.

Step 404: Compare the adjusted signal classification decision threshold with the signal characteristics of the current frame to decide the signal type of the current frame.

The detecting whether the current frame is in the first type signal state includes: comparing an adjustment threshold decision parameter with a preset value, and deciding, according to a comparison result, whether the current frame is in the first type signal state.

The adjusting the signal classification decision threshold according to whether the current frame is in the first type signal state includes adjusting a background/foreground decision threshold, a useful signal decision threshold, or a speech/music decision threshold.

The comparing the adjusted signal classification decision threshold with the signal characteristics of the current frame to decide the signal type of the current frame includes: comparing the adjusted background/foreground decision threshold with the signal characteristics of the current frame to decide whether the current frame is a background signal frame, comparing the adjusted useful signal decision threshold with the signal characteristics of the current frame to decide whether the current frame is a useful signal frame, and comparing the adjusted speech/music decision threshold with the signal characteristics of the current frame to decide whether the current frame is a speech frame or a music frame. By adjusting the signal classification decision threshold, the capability of identifying different types of signals is enhanced during the classification of signals.

According to each embodiment, a non-speech background in signals can be identified, and a signal classification decision threshold is adjusted after the non-speech background in the signals is identified. The adjustment of the threshold effectively reduces the ratio of erroneous recognition of signals. Further, the adjusted threshold is used for deciding whether the input signals are useful signals and used in classifying speech and non-speech signals in the input signals, so that the capability of identifying speech signals in the non-speech background and the signal processing quality are enhanced effectively. Each embodiment above may be applied to speech and audio coding and may also be applied to all communication technologies, network technologies, and computer solutions directed to multiple types of signals in environments where different types of signals are required to be differentiated.

It is understandable to persons of ordinary skill in the art that all or part of the steps in the method of the preceding embodiments may be implemented by related hardware instructed by a computer program. The program may be stored in a computer readable storage medium. When the program runs, the processes of the preceding method embodiments are executed. The storage medium may be a magnetic disk, a CD-ROM, a read-only memory (Read-Only Memory, ROM), or a random access memory (Random Access Memory, RAM).

Finally, it should be noted that the above embodiments merely exemplary. Although the embodiments are described in detail, it is understood that modifications or substitutions can be made to the embodiments. Such modified embodiments are understood to fall with the scope of the claims.

What is claimed is:

1. A signal identifying device, comprising:
a background signal decision module configured to determine, according to signal characteristics of a current frame and updated signal characteristics of a background signal frame before the current frame, whether the current frame is a background signal frame;
a signal characteristic detection module configured to detect whether the current frame is in a first type signal state; and
a first threshold adjustment module configured to adjust a signal classification decision threshold according to whether the current frame is in the first type signal state.

2. The device according to claim 1, wherein adjustment of the signal classification decision threshold comprises: adjusting a background/foreground decision threshold, a useful signal decision threshold, or a speech/music decision threshold.

3. The device according to claim 2, wherein the background signal decision module comprises:
a characteristic correlation unit configured to correlate the updated signal characteristics of the background signal frame before the current frame with the signal characteristics of the current frame to obtain correlated signal characteristics of the current frame; and
a background signal decision unit configured to compare the correlated signal characteristics of the current frame with the background/foreground decision threshold to determine whether the current frame is a background signal frame.

4. The device according to claim 3, further comprising a background signal updating unit configured to update a background signal of the current frame that is determined by the background signal deciding unit as a background signal frame, wherein the updated background signal is used by the background signal decision unit in determining whether a subsequent frame is a background signal.

5. The device according to claim 3, wherein the background/foreground decision threshold compared in the background signal decision unit is obtained by presetting the background/foreground decision threshold, or through adjustment according to whether the current frame or the background signal frame before the current frame is in the first type signal state.

6. A signal identifying device, comprising:
a background signal decision module configured to determine, according to signal characteristics of a current frame and updated signal characteristics of a background signal frame before the current frame, whether the current frame is a background signal frame;
a tonal characteristic obtaining module configured to obtain tonal characteristics of the current frame serving as a background signal frame and tonal characteristics of multiple background signal frames before the current frame;
a signal characteristic correlation module configured to correlate the tonal characteristics of the current frame and the tonal characteristics of the multiple background signal frames before the current frame; and
a first type signal module configured to compare the correlated tonal characteristics with a first threshold, and determine, according to a comparison result, whether the current frame serving as a background signal frame is a first type signal.

7. The device according to claim 6, wherein the first type signal module comprises a second threshold adjustment module that is configured to adjust the signal classification decision threshold according to the comparison result, wherein the second threshold adjusting module comprises:
a first type signal characteristic decision unit configured to compare the correlated tonal characteristics with the first threshold to determine an adjustment threshold decision parameter;
an adjustment threshold decision unit configured to compare the adjustment threshold decision parameter with a threshold; and
a threshold adjustment unit configured to adjust the signal classification decision threshold according to a comparison result of the adjustment threshold decision unit;
wherein the second threshold adjustment module is independent of the first type signal module and configured to adjust the signal classification decision threshold, wherein the second threshold adjustment module comprises:
an adjustment threshold decision unit configured to compare an adjustment threshold decision parameter with a threshold; and
a threshold adjustment unit configured to adjust the signal classification decision threshold according to the comparison result of the adjustment threshold decision unit.

8. The device according to claim 7, further comprising:
a counter configured to perform a counting operation on the multiple background signal frames that are before the current frame that are correlated by the signal characteristic correlation module; and
a subtractor configured to perform a subtraction operation on the adjustment threshold decision parameter value when the tonal characteristics of the multiple background signal frames before the current frame are correlated by the signal characteristic correlating module.

9. A signal classifying device, comprising:
a signal judging module configured to make a first decision according to signal characteristics of a current frame and updated signal characteristics of multiple background signal frames before the current frame, to decide whether the current frame is a useful signal frame;
a signal characteristic module configured to obtain the signal characteristics of the current frame serving as a useful signal frame and signal characteristics of multiple useful signal frames before the current frame; and
a signal decision module configured to make a second decision according to the signal characteristics of the current frame and the signal characteristics of the multiple useful signal frames before the current frame, to decide a signal type of the current frame, wherein the first decision or second decision is made based on a signal classification decision threshold, and the signal classification decision threshold is obtained through adjustment according to whether the current frame or a background signal frame before the current frame is in a first type signal state.

10. The device according to claim 9, wherein adjustment of the signal classification decision threshold comprises: adjusting a background/foreground decision threshold, a useful signal decision threshold, or a speech/music decision threshold.

11. The device according to claim 10, wherein the signal judging module comprises:
a characteristic correlating unit configured to correlate updated signal characteristics of one or more background signal frames before the current frame with the signal characteristics of the current frame to obtain correlated signal characteristics of the current frame; and
a useful signal frame deciding unit configured to make the first decision with respect to the correlated signal characteristics of the current frame and the useful signal decision threshold to decide whether the current frame is a useful signal frame.

12. The device according to claim 11, wherein the useful signal decision threshold of the useful signal frame decision unit comprises a preset useful signal decision threshold or is obtained through adjustment according to whether the current frame or the background signal frame before the current frame is in the first type signal state; and
the device further comprises a threshold searching unit configured to search a signal frame decision threshold to find whether a useful signal decision threshold of the current frame or the background signal frame before the current frame is adjusted; if the useful signal decision threshold is adjusted, the useful signal frame deciding unit compares the adjusted useful signal decision threshold with the correlated signal characteristics of the current frame; otherwise, the useful signal frame deciding unit compares the preset useful signal decision threshold with the correlated signal characteristics of the current frame.

13. The device according to claim 11, wherein the signal decision module comprises:
a decision comparison unit configured to compare the signal characteristics of the multiple useful signal frames comprising the current frame with the speech/music decision threshold; and
a signal classification unit configured to: if the number of frames with the signal characteristics greater than or equal to the speech/music decision threshold is greater than the number of frames with the signal characteristics smaller than the speech/music decision threshold, determine that the current frame is a speech frame, or else, determine that the current frame is a first type signal frame.

14. The device according to claim 12, wherein obtaining of the signal classification decision threshold through adjustment according to whether the current frame or the background signal frame before the current frame is in the first type signal state comprises:
obtaining the signal classification decision threshold by adjusting the background/foreground decision threshold by comparing an adjustment threshold decision parameter with a threshold.

15. A signal processing system, comprising:
a signal characteristic obtaining device configured to obtain signal characteristics of a current frame of input signals;
a signal identification device configured to detect, according to the signal characteristics of the current frame, whether the current frame is a background signal frame, and adjust a signal classification decision threshold according to whether the current frame as a background frame is in a first type signal state; and
a signal classification device configured to determine, according to the signal characteristics of the current frame, whether the current frame is a useful signal frame, and decide a signal type of the current frame as a useful signal frame, wherein the decision on whether the current frame is a useful signal frame or the decision on the signal type of the current frame serving as a useful signal frame is made based on the signal classification decision threshold, and the signal classification decision threshold is obtained through adjustment according to whether the current frame or a background signal frame before the current frame is in the first type signal state.

16. The system according to claim 15, wherein the signal classification device comprises:
a characteristic correlation unit configured to correlate updated signal characteristics of the background signal frame before the current frame with the signal characteristics of the current frame to obtain correlated signal characteristics of the current frame;
a useful signal frame decision unit configured to make a first decision with respect to the correlated signal characteristics of the current frame and a useful signal decision threshold to decide whether the current frame is a useful signal frame;
a signal characteristic unit configured to obtain the signal characteristics of the current frame serving as a useful signal frame and signal characteristics of multiple useful signal frames before the current frame;
a decision comparing unit configured to compare signal characteristics of multiple useful signal frames comprising the current frame with a speech/music decision threshold; and
a signal classification unit configured to: if the number of frames with the signal characteristics greater than or equal to the speech/music decision threshold is greater than the number of frames with the signal characteristics smaller than the speech/music decision threshold, decide that the current frame is a speech frame, or else, decide that the current frame is a first type signal frame.

17. An audio signal coding system, comprising:
a signal input device configured to receive audio signals;
a signal classification device configured to decide, according to signal characteristics of a current frame, whether the current frame is a useful signal frame, and decide a signal type of the current frame serving as a useful signal frame, wherein the decision on whether the current frame is a useful signal frame or the decision on the signal type of the current frame serving as a useful signal frame is made based on a signal classification decision threshold, and the signal classification decision threshold is obtained through adjustment according to whether the current frame or a background signal frame before the current frame is in a first type signal state; and
a signal coding device configured to use, according to the signal type of the current frame that is determined to be a useful signal frame, a coder to perform coding for different types of signals to obtain coded bit streams comprising different types of signals.

18. A signal deciding device, comprising:
a module configured to obtain signal characteristics of a current frame of input signals;
a module configured to decide whether the current frame is in a first type signal state, and determine a signal classification decision threshold according to whether the current frame is in the first type signal state; and
a module configured to compare the determined signal classification decision threshold with the signal characteristics of the current frame to decide a signal type of the current frame.
